(19) United States
(12) Patent Application Publication
(10) Pub. No.: US 2004/0205111 A1
(43) Pub. Date: Oct. 14, 2004

(54) User configurable data messages in industrial networks

(76) Inventors: Zaki Chasmawala, Austin, TX (US); Brian Ruhmann, Austin, TX (US); Sadia Malik, Austin, TX (US)

Correspondence Address: Jeffrey C. Hood, Meyertons, Hood, Kivlin, Kowert & Goetzel, P.O. Box 398, Austin, TX, 78767, US

(21) Appl. No.: 10/714,490

(22) Filed: Nov. 14, 2003

Related U.S. Application Data
(60) Provisional application No. 60/426,718, filed on Nov. 15, 2002.

(51) Int. Cl. G06F 15/16

(52) U.S. Cl. 709/201

(57) ABSTRACT

A system and method for a system and method for a communication network that includes network devices. The network devices can communicate with each other using the communication network by transmitting and receiving data messages. A first network device and a second network device may each include one or more inputs and one or more outputs. The second network device may be coupled to a host computer. A data message may be created and sent by the first network device to the second network device, where the first data message includes user configurable data, where the user configurable data is configured using the host computer. A network device may offer the flexibility to allocate both analog and discrete data to specific data bytes in the same data message.

### PRIORITY CLAIM

This application claims benefit of priority of U.S. provisional application Serial No. 60/426,718 titled “User Configurable Data Messages in Industrial Networks” filed Nov. 15, 2002, whose inventors were Zaki Chasmawala, Brian Ruhmann, and Sadia Malik.

### FIELD OF THE INVENTION

The present invention relates to the field of communication networks. In particular, the invention relates to a system and method for user configurable data messages on a communication network.

### DESCRIPTION OF THE RELATED ART

FIG. 1 (Prior Art)

FIG. 1 illustrates a general bus (network) 2 that may have a serial data connection and may be operable to connect field devices such as sensors, actuators, drives, distributed input and/or output (I/O), and/or distributed regulators, with the controlling personal computer (PC) or a Programmable Logic Controller (PLC) 1. A controller area network (CAN) is a serial, asynchronous, multimaster communication protocol for connecting electronic control modules in automotive and industrial applications. CAN was designed for applications needing high-level data integrity and data rates of up to 1 Mbit/s.

Historically, CAN networks were predominantly automotive. Because of its technical merits and low cost, CAN has found acceptance in markets other than automotive. Some examples are aerospace, maritime, medical equipment, farm machinery, manufacturing (motion control, robots) etc. CAN is now being used not only in network automotive devices (sensors and actuators), but also in medical equipment (x-ray machines), robots, copy machines, and recreation vehicles, among others.

Using CAN, devices (controllers, sensors, and actuators) 3-8 are connected on a common serial bus 2. This network of devices can be thought of as a scaled-down and real-time version of networks used to connect personal computers. Any device on a CAN network 2 can communicate with any other device using a common pair of wires.

On a CAN network 2, every CAN message may be given a unique arbitration ID. The arbitration ID determines the device's priority to transmit CAN messages on the CAN network. The lower the number of the arbitration ID, the higher is its priority. The arbitration ID may be determined by the system designer at network design time. Devices that perform critical functions are given higher priority arbitration IDs. Because of this arbitration scheme, no two devices with the same arbitration ID can exist on a CAN network.

FIG. 2 (Prior Art)

A CAN message may contain eight bytes in which information can transmitted, as illustrated in FIG. 2. A CAN device can be considered a smart sensor, or an actuator, that multiplexes measurement data from traditional A/D or D/A converters or discrete bits (on/off) in the eight data bytes. It may support more than one CAN message depending on the design of the device, the resolution of the digitized data and the number of interfaced sensors or actuators. The CAN device may then transmit the resulting CAN message with input (measurement) or sensor data or accept a CAN message from the network to update the output or actuator.

FIG. 3 (Prior Art)

A CAN device may be designed for a specific application, as illustrated in FIG. 3, in which it may service a limited number of inputs and/or outputs and utilize a fixed number of CAN messages in which the data is pre-allocated in the data bytes of the CAN message.

Network modules currently exist with associated input and output channels (I/O channels) that are operable to expose the I/O channels packed in CAN messages. Essentially, these network modules and the associated I/O channels become CAN devices on the network. They may allow custom configuration of the I/O channels, such as sensor data, in CAN data messages. For example, for input I/O, the network module transmits data messages on the CAN network. The network module also accepts messages from the CAN network to update output I/O channels.

Several applications demand flexibility in the configuration of the data message, such as the CAN data message, and the way the data is transmitted on the network. It may become necessary to configure a data message that groups measurements from a certain physical location. Another application may require measurements to be grouped together to be transmitted in a high priority periodic data message. Some applications may also need to transmit a data message that contains analog data on a digital trigger. A similar application may need to transmit a data message with analog data when one of the data values crosses a threshold level or a percent dead band.

### SUMMARY OF THE INVENTION

One embodiment of the invention comprises a communication network that includes network devices. The network devices can communicate with each other using the communication network by transmitting and receiving data messages. A first network device and a second network device may each include one or more inputs and one or more outputs. The second network device may be coupled to a host computer. A data message may be created and sent by the first network device to the second network device, where the first data message includes user configurable data, where the user configurable data is configured using the host computer. A network device may offer the flexibility to allocate both analog and discrete data to specific data bytes in the same data message.

A network device, such as a CAN device, may be designed in the form of a network device that can be connected to different I/O interfaces, for signal conditioning and digitizing to various sensor types. For example, this network device may have a default mechanism of configuring the digitized sensor information in CAN messages on initialization. This network device may assign I/O data to the data messages and may provide the capability for a user to specify the location in the data bytes of the data message where the sensor information should be inserted.

The network device may also provide information about how much data space remains in the data message, such as a CAN data message, as well as provide information about the signals that have not been assigned to a data message. The network device may communicate with a graphical configuration tool on a host computer that will graphically display the data message configuration and allow a system designer to manipulate the data bytes. The network device may also permit the allocation of a new data message identifier to accommodate existing network devices.

### BRIEF DESCRIPTION OF THE DRAWINGS

A better understanding of the present invention can be obtained when the following detailed description of the preferred embodiment is considered in conjunction with the following drawings, in which:

FIG. 1 illustrates a Prior Art topology of a general industrial network that includes a control computer and distributed I/O and/or sensors/actuators;

FIG. 2 illustrates Prior Art various frame formats of data messages;

FIG. 3 illustrates a Prior Art device with fixed frame formats;

FIG. 4 is a block diagram of a network and a reconfigurable network device, according to one embodiment;

FIG. 5 is a block diagram of a reconfigurable network device, according to one embodiment;

FIG. 6 is a table of an exemplary channel and arbitration ID scheme for initialization, according to one embodiment;

FIG. 7 is a table of an exemplary channel and arbitration ID scheme after a modification where all channels are used, according to one embodiment;

FIG. 8 is a graphical view of an exemplary arbitration ID, according to one embodiment;

FIG. 9 illustrates an application used to configure a network, according to one embodiment;

FIG. 10 illustrates scanning and listing devices on the network, according to one embodiment;

FIG. 11 illustrates configuration of a network device on the industrial network, including I/O channels, according to one embodiment;

FIG. 12 illustrates configuration of an I/O point of the network device, according to one embodiment;

FIG. 13 illustrates configuration of a data message, according to one embodiment;

FIG. 14 illustrates saving of the configuration of the network device, according to one embodiment;

FIG. 15 illustrates a graphical configuration tool accessing channels on the network, according to one embodiment;

FIG. 16 illustrates the graphical configuration tool accessing channels on the network, according to one embodiment;

FIG. 17 illustrates the graphical configuration tool accessing the network device, according to one embodiment;

FIG. 18 illustrates the graphical configuration tool monitoring data on the network, according to one embodiment;

FIG. 19 illustrates accessing a test panel to test channels, according to one embodiment;

FIG. 20 illustrates using the test panel to read and write values, according to one embodiment;

FIG. 21 illustrates accessing channel properties page, according to one embodiment;

FIG. 22 illustrates a diagram of a graphical program that accesses data on the network, according to one embodiment; and

FIG. 23 illustrates a front panel of the graphical program that accesses data on the network, according to one embodiment.

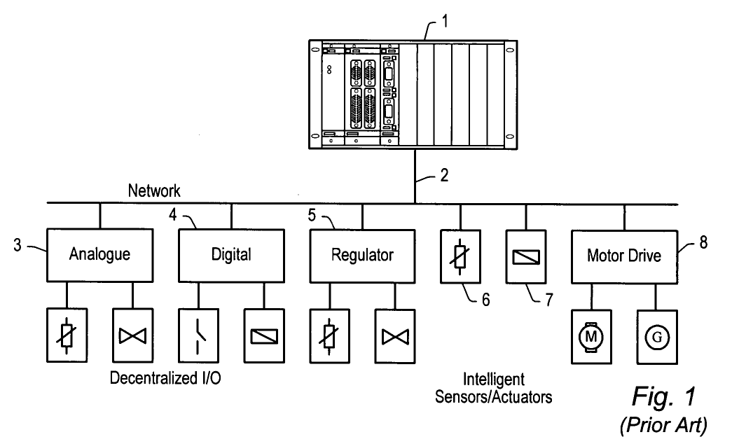

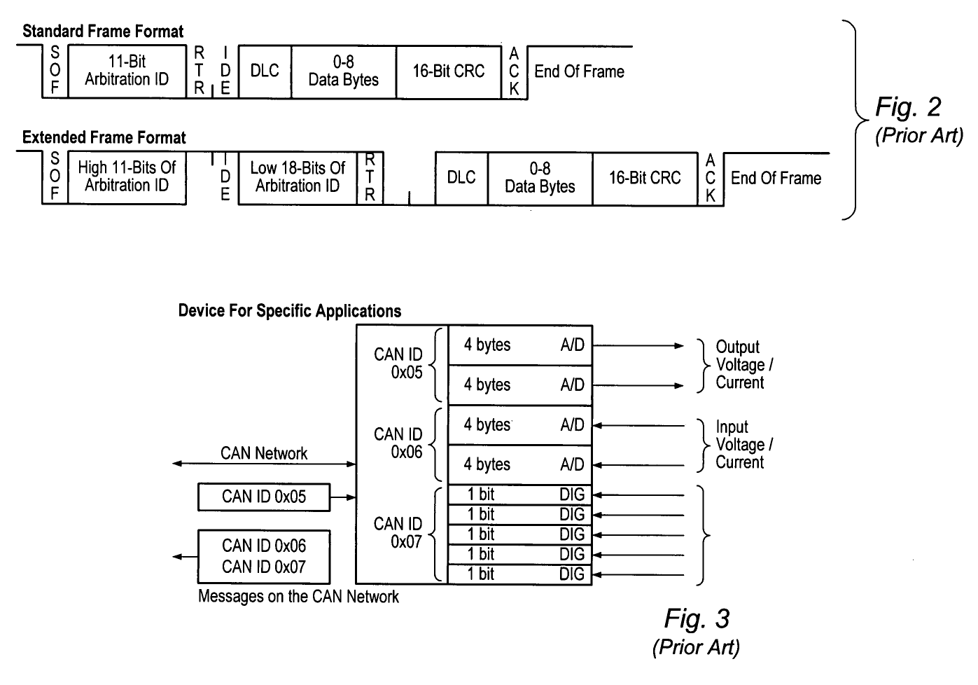

### DESCRIPTION

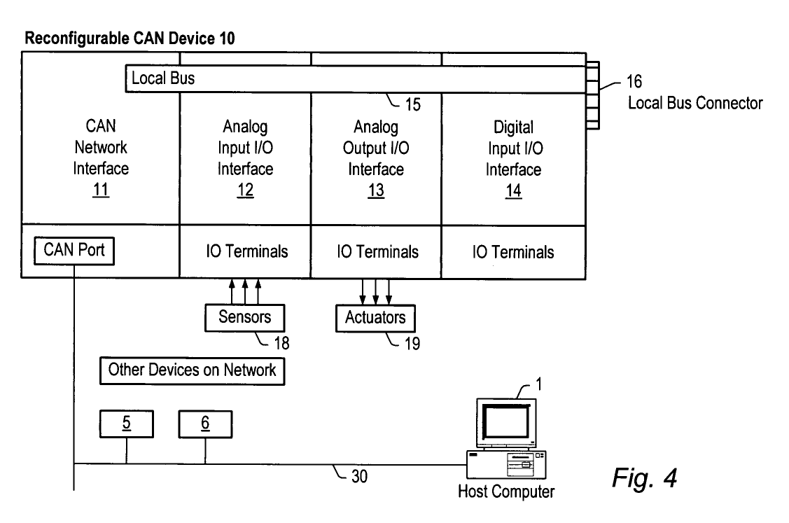

FIG. 4-Block Diagram of a Network and a Reconfigurable Network Device

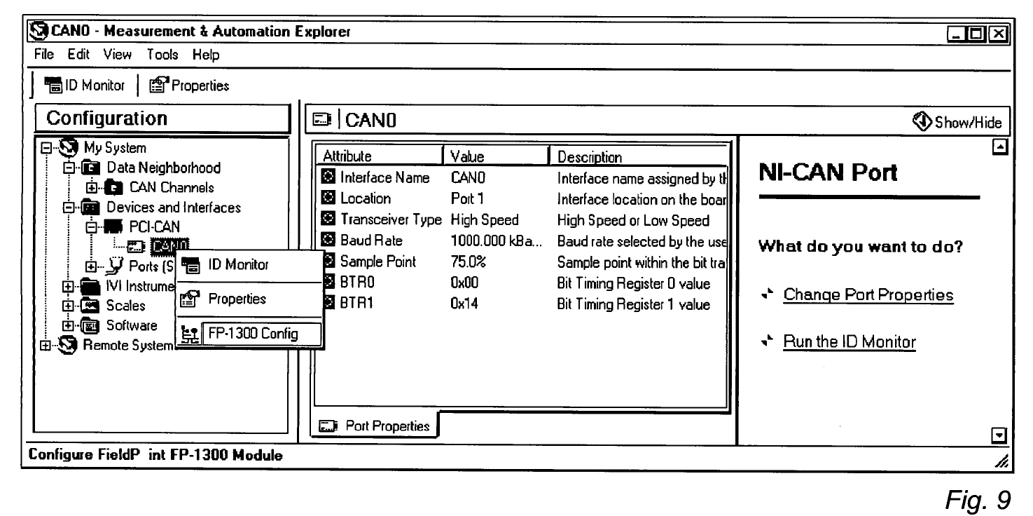

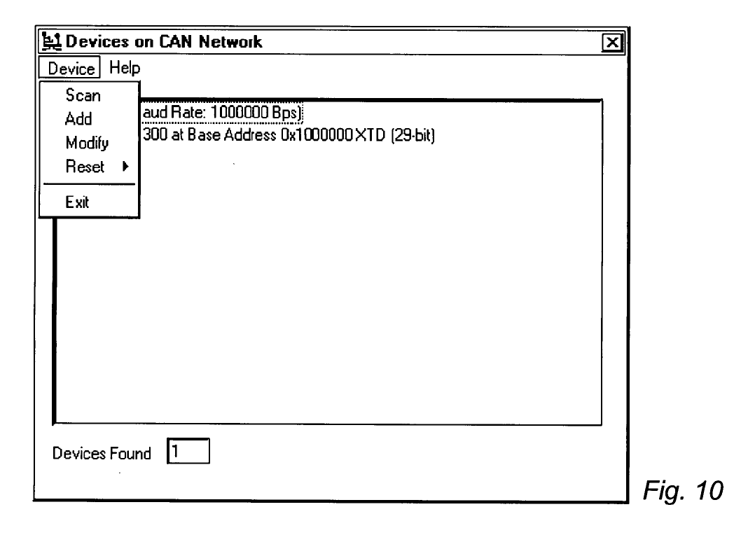

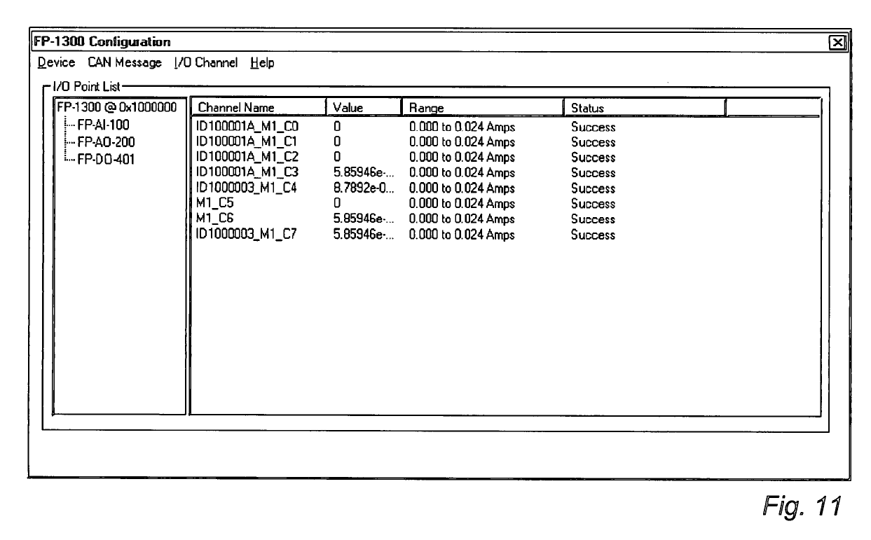

FIG. 4 illustrates a block diagram of a network and a reconfigurable network device 10, such as a reconfigurable CAN device, according to one embodiment. The network device 10 is an interface that communicates via a local bus 15 with the I/O interfaces 12-14 that allow connections to sensors 18 and/or actuators 19. The network device 10 also may communicate with other devices 5-6 on the network 30. Furthermore, in one embodiment, software, such as described in above with reference to FIGS. 9-23, may consist of configuration software, such as a graphical configuration tool, running on a host computer 1 that is capable of transmitting commands via messages to the network device 10. A network interface, such as a second network device coupled to the host computer 1, may be necessary for the host computer 1 to connect to the network 30.

In one embodiment, the network device 10 may consist of a microprocessor (not shown), non-volatile memory (not shown), a network controller (not shown), such as a CAN network controller with a physical layer interface, and a local bus interface (not shown) to communicate with the I/O interfaces. The microprocessor may execute firmware that detects and configures the I/O interfaces, determines data size of an associated channel and allocates the channel to a data message, such as a CAN data message. The firmware may also accept configuration commands from the host computer via the CAN interface and perform runtime CAN functions for the network device. The configuration may be saved to the non-volatile memory of the network device.

In one embodiment, the network device 10 may allocate a range of 255 arbitration IDs. The network device 10 may allocate arbitration IDs required for accommodating the I/O channels from the connected I/O interfaces 12-14. The network device may reserve the first two arbitration IDs beginning with the base arbitration ID for configuration requests and responses. The remaining 253 arbitration IDs may be used for I/O channels. In one embodiment, the first ID, also referred to as the base arbitration ID, can be set either by DIP switches on the network device 10 or by the user from the host computer 1, among others.

It is noted that the block diagram of FIG. 4 is exemplary only. Further, various blocks of FIG. 4 may be present in different order than that shown, or may not be present, as desired. Also, various additional blocks may be included as desired.

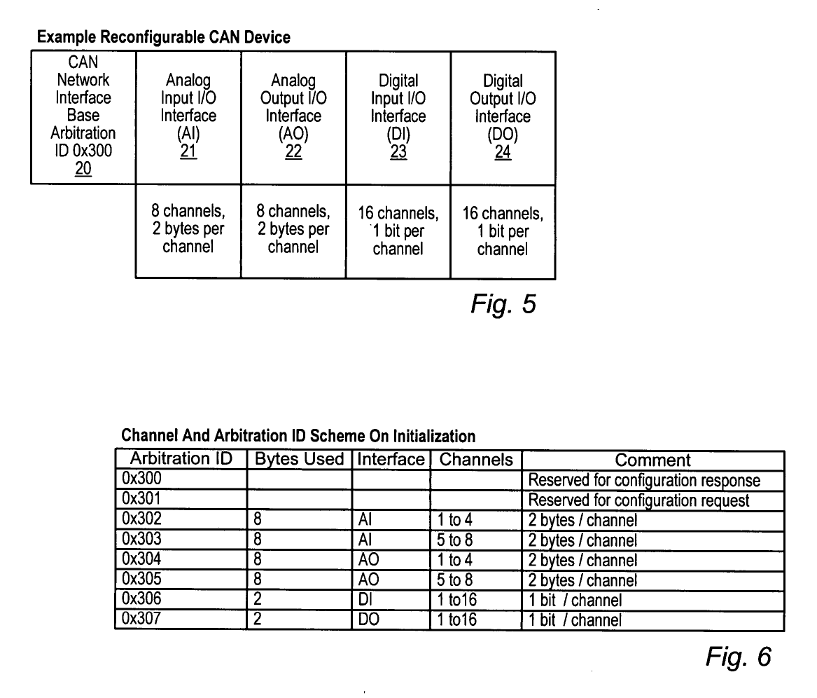

FIG. 5—Block Diagram of a Reconfigurable Network Device

FIG. 5 illustrates a block diagram of a reconfigurable network device, according to one embodiment.

In one embodiment, on initial power-up of the network device, the network device 10 may detect the base arbitration ID, such as from the DIP switches or non-volatile memory. The network device may consecutively allocate arbitration IDs, as offset from the base arbitration ID, and allocate channels to data bytes beginning with the first I/O (input or output) interface. On completely populating the 8 data bytes of the data message, such as the CAN data message, the network device may allocate another data message if it detects unallocated channels, and begin the allocation process again. If an I/O interface consists of both input and output I/O types, then the network device may allocate a new arbitration ID after populating an arbitration ID with one type of I/O.

In one embodiment, FIG. 5 illustrates a block diagram of a reconfigurable network device, such as a reconfigurable CAN device. For example, a CAN network interface 11 may have an base arbitration ID of 0x300. The CAN network interface 11 may interface to an analog input I/O interface 12, an analog output I/O interface 13, and a discrete input I/O interface 14, all connected by a local bus 15.

It is noted that the block diagram of FIG. 5 is exemplary only. Further, various blocks of FIG. 5 may be present in different order than that shown, or may not be present, as desired. Also, various additional blocks may be included as desired.

FIG. 6—Table of Channel and Arbitration ID Scheme on Initialization

FIG. 6 illustrates an exemplary initial channel and arbitration ID scheme for initialization, according to one embodiment. For example, the arbitration IDs 0x300 and 0x301 may be reserved for configuration response and request. Arbitration IDs 0x302 and 0x303 may be reserved for analog input channels. Arbitration IDs 0x304 and 0x305 may be reserved for analog output channels. Arbitration IDs 0x306 and 0x307 may be reserved for discrete input and discrete output channels respectively.

In one embodiment, once the configuration step is completed the network device may be switched to a run mode, where it may transmit messages, such as CAN messages, that have input I/O channels, and accepts messages, such as CAN messages, from the network to update any outputs.

It is noted that the table of FIG. 6 is exemplary only. Further, various entries of FIG. 6 may be present in different order than that shown, or may not be present, as desired. Also, various additional entries may be included as desired.

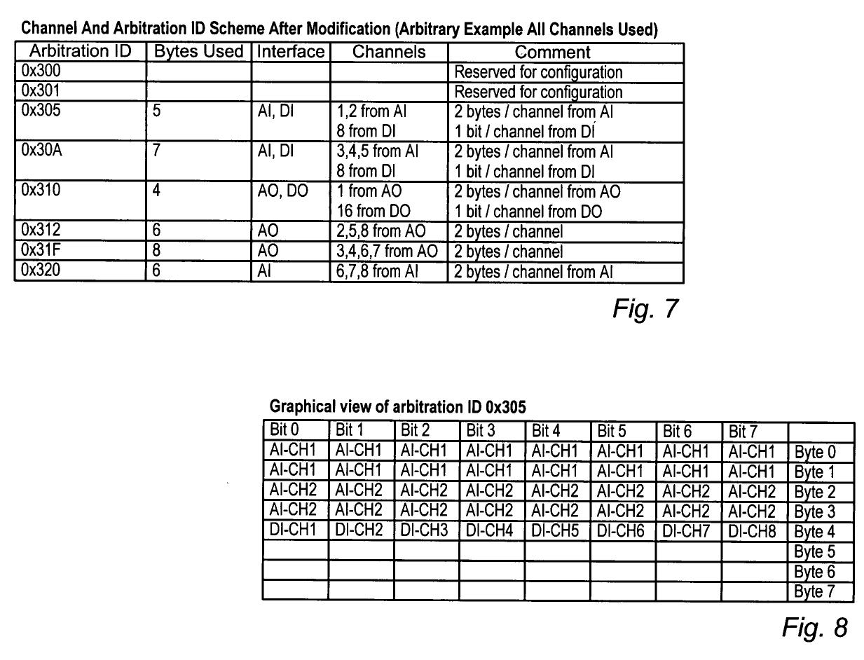

FIG. 7—Table of Channel and Arbitration Scheme after Modification

FIG. 7 illustrates example channel and arbitration ID scheme after a modification where all channels are used, according to one embodiment.

In one embodiment, a system designer may choose which channel is included in a data message, such as a CAN data message, using a graphical configuration tool, such as described below with reference to FIGS. 9-11. The network device 10 may allocate analog and discrete channels of the same type (either input or output), in the same data message. A new analog or discrete channel may be inserted at a new byte boundary within the 8 data bytes. A discrete channel from one I/O interface can be allocated adjacent to a channel from another I/O interface within the same byte. The hardware interface may allow empty bit spaces within a byte, but may not allow an entire empty byte space except at the end of the data message. On every user interaction, the graphical configuration tool on the host computer may be updated with the network device configuration. Table in FIG. 7 shows an exemplary configuration of I/O channels and reallocated IDs, and table in FIG. 8 shows a graphical view of an exemplary arbitration ID (0x305).

For example, the arbitration IDs 0x300 and 0x301 may be reserved for configuration response and request. Arbitration ID 0x305 may be reserved for two analog input channels and eight discrete input channels. Arbitration ID 0x30A may be reserved for three analog input channels and eight discrete input channels. Arbitration ID 0x310 may be reserved for one analog output channel and sixteen discrete output channels. Arbitration ID 0x312 may be reserved for 3 analog output channels. Arbitration ID 0x31F may be reserved for four analog output channels. Arbitration ID 0x320 may be reserved for three analog input channels. In one embodiment, each analog input or output channel uses two bytes. In one embodiment, each discrete input or output channel uses one bit.

It is noted that the table of FIG. 7 is exemplary only. Further, various entries of FIG. 7 may be present in different order than that shown, or may not be present, as desired. Also, various additional entries may be included as desired.

FIG. 8—Graphical View of Exemplary Arbitration ID

FIG. 8 illustrates a graphical view of an exemplary arbitration ID (0x305), according to one embodiment.

In one embodiment, the exemplary arbitration ID, 0x305, may contain two analog input channels and eight discrete input channels. For example, bytes 0 and 1 may contain data for analog input channel 1, two bytes per analog channel. Bytes 2 and 3 may contain data for analog input channel 2, two bytes per analog channel. Byte 4 may contain data for discrete input channels 1-8, one bit per discrete channel.

It is noted that the table of FIG. 8 is exemplary only. Further, various entries of FIG. 8 may be present in different order than that shown, or may not be present, as desired. Also, various additional entries may be included as desired.

FIGS. 9-11—Graphical Configuration of I/O Channels on Network Device

According to one embodiment, FIGS. 9-11 illustrate graphical configuration of I/O channels on the network device 10 using a graphical configuration tool. After the I/O channels and CAN messages are configured, the configuration can be loaded into the graphical configuration tool and accessed from another application, such as a graphical program. The graphical configuration tool may expose the configuration parameters for the network device to an API that is accessible by programming development environments, such as a graphical program development environment, or a textual program development environment, such as a Microsoft Studio, Java, and C/C++, among others. As a result, offset and scaling information to decode the I/O data may not be necessarily contained in a data message.

In one embodiment, the graphical configuration tool can be used to configure data messages to be transmitted in several different ways:

periodical determinism,

change of a state,

reaching a predetermined level, and

poll from the communication network, among others.

For example, users may benefit from this feature by having data, such as temperature data, assigned to messages that are transmitted only on change of state, and have other analog or discrete data periodically transmitted. The level based transmission is particularly useful for alarming purposes. A level based message can be transmitted either periodically or once on reaching a high or low level. The network device may allow full configuration of channels, including the way they are packed in a data message, such as a CAN data message. For input I/O modules, the network device may transmit CAN messages either periodically, on a change of state (% dead band), on level, or on a poll message. For output I/O modules, the network device may accept messages from the CAN bus to update the outputs.

In one embodiment, the network device allows an ability to prototype a device before hardware development. For example, the network device may be used as a CAN device instead of developing custom hardware.

In one embodiment, with the graphical configuration tool, the data messages, such as CAN data messages, can be packed with I/O data from different I/O modules, such data from the network interfaces 12-14 from the network module 10. In one embodiment, only input I/O data can only be packed into an input type data message and output I/O data type can only be packed into output type data message. As a result a data message, such as a CAN data message, can contain both analog and discrete data.

In one embodiment, this feature can be used to differentiate CAN message IDs from different physical sections of a device, such as a vehicle. This feature may be used to transmit analog data on a discrete trigger input, if both the analog channel and discrete channel are packed in one data message and the I/O and the data message are configured appropriately.

In one embodiment, the network module communicates using raw CAN network protocol, and may not need a master device to communicate with it, such as when using CAN Higher Level Protocols, or HLPs, such as CAL, CANOpen or DeviceNet, among others. The network device allows the user flexibility to configure any type of a data channel into a data message, such as a CAN data message. For example, the CAN device can be configured for either standard (11-bit) or extended (29-bit) message (arbitration) IDs.

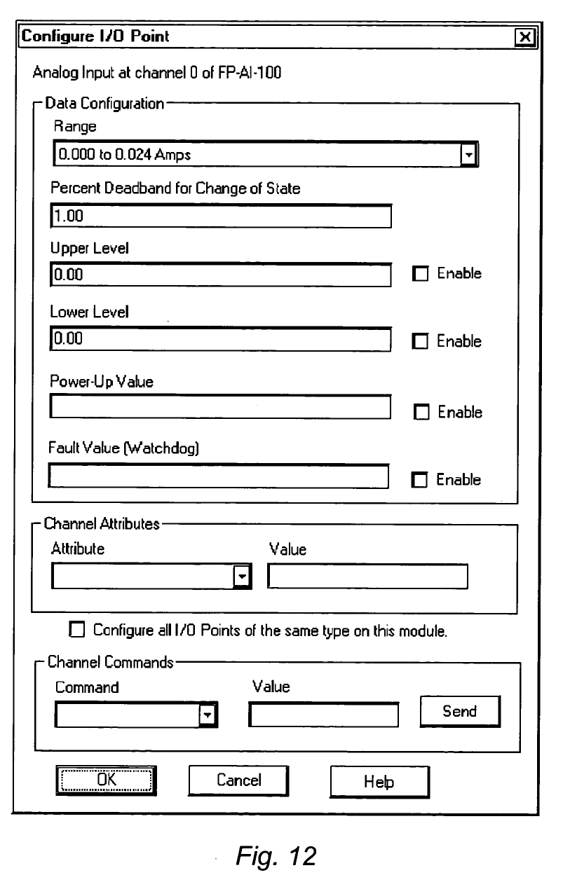

FIGS. 12-14—Graphical Configuration of I/O Points

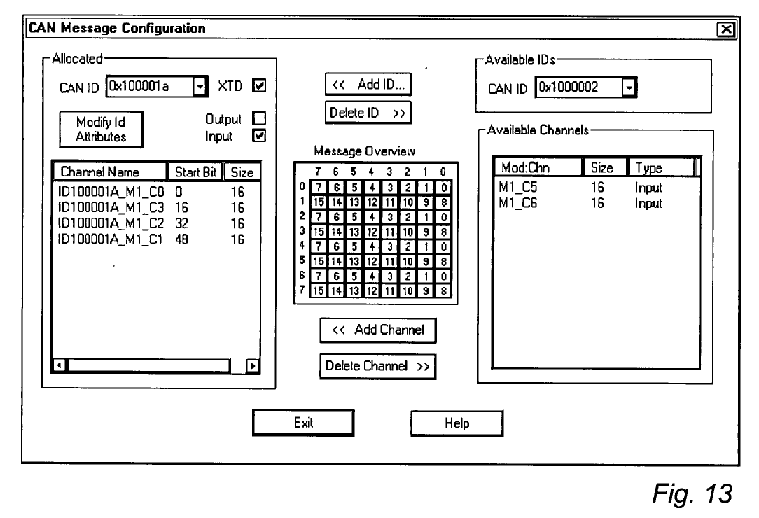

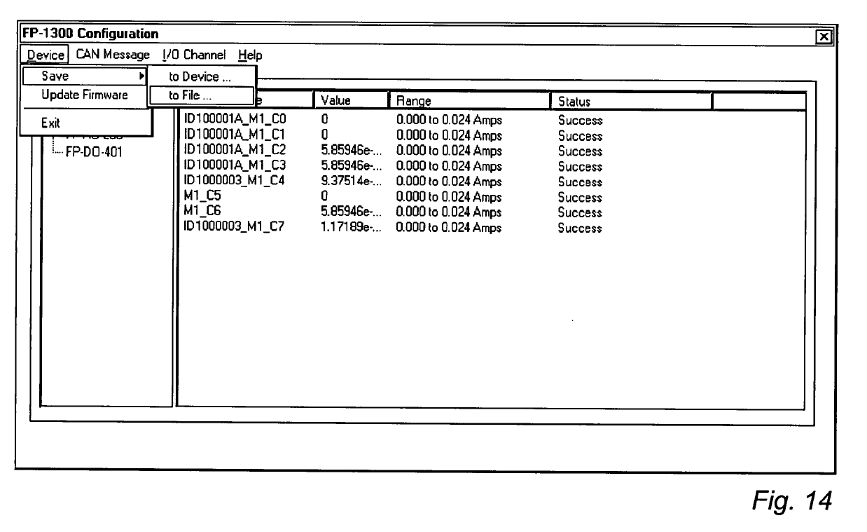

FIG. 12 illustrates configuration of an I/O point of the network device, according to one embodiment. FIG. 13 illustrates configuration of a data message, according to one embodiment. FIG. 14 illustrates saving of the configuration of the network device, according to one embodiment.

Data messages, such as CAN data messages, may be either of input or output type. Hence, an input type data message can contain I/O channels that can interface with sensors and an output type data message can contain I/O channel that can interface with actuators. If the end of the I/O interface is reached (all channels in the I/O interface are allocated), then the network device 10 may allocate another arbitration ID and continue with the next I/O interface. If an I/O interface consists of channels that can partially populate the entire 8 bytes of the data message, then some portion of the data message may be left unpopulated and a new arbitration ID may be allocated for the next I/O interface. If no more I/O interfaces are available, then the network device 10 may save the current configuration to the non-volatile memory.

The saved configuration may be retrieved and modified by accessing the network device via the host computer, such as via a configuration data message, running a configuration application and communicating over the network, such as the CAN bus. The configuration application, such as a graphical configuration tool, may query the hardware interface, such as described above with reference to FIGS. 9-11, for the allocated arbitration IDs and the I/O channels associated with the allocated arbitration IDs. In one embodiment, the configuration application may allow a user to override the information saved in the non-volatile memory, reconfigure, and save a new configuration. All of the allocated arbitration IDs may be deleted and new arbitration IDs may be allocated from the range of 253 arbitration IDs. At the time of allocation, the user may define if the data message, such as a CAN data message, is of input or output type. When an arbitration ID is deleted then all the I/O channels previously populating it may become unallocated. These channels may be allocated to a data message if the I/O type matches and if the space in the data message is adequate to accept the channel.

A configuration data message may be sent out that includes the information about the content of the data messages, including channel names, channel content, arbitration information, baud rate, and other configuration as described in FIGS. 7-14.

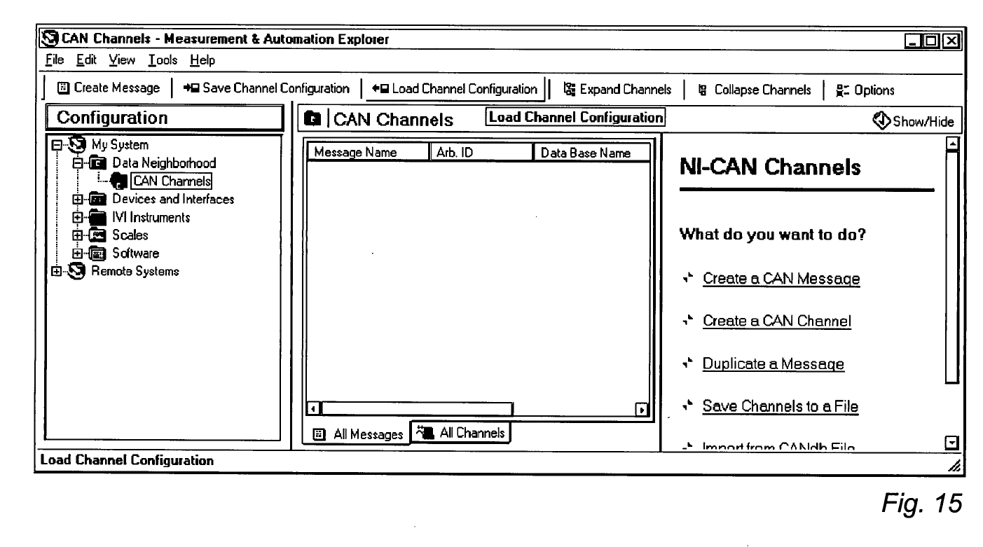

FIGS. 15-21—Graphical Monitoring of Configured Channels and I/O Points

FIG. 15 illustrates the graphical configuration tool accessing channels on the network, according to one embodiment. For example, the user can graphically access channels on the network by accessing the CAN Channels option in the Data Neighborhood folder using the graphical configuration tool.

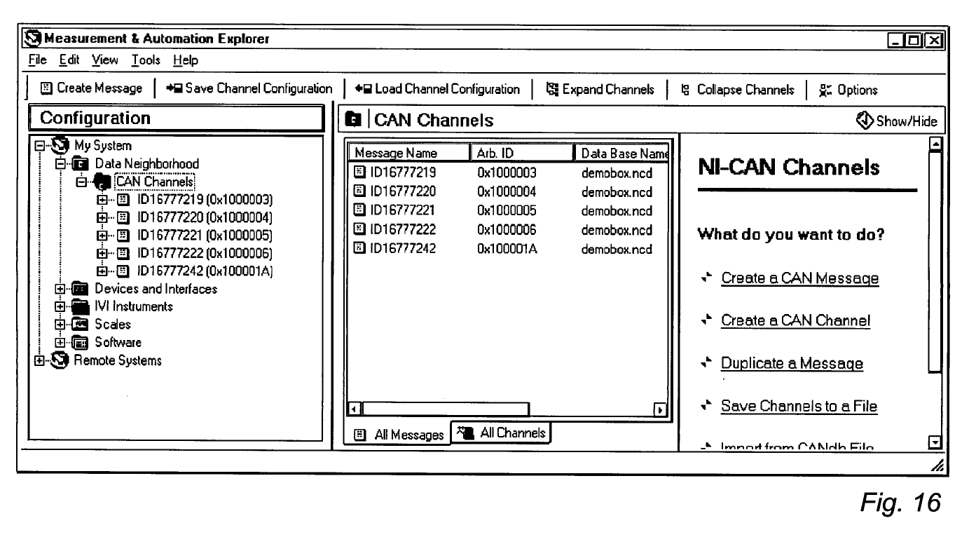

FIG. 16 illustrates the graphical configuration tool accessing channels on the network, according to one embodiment. For example, CAN channels with corresponding arbitration IDs may be displayed in the graphical configuration tool.

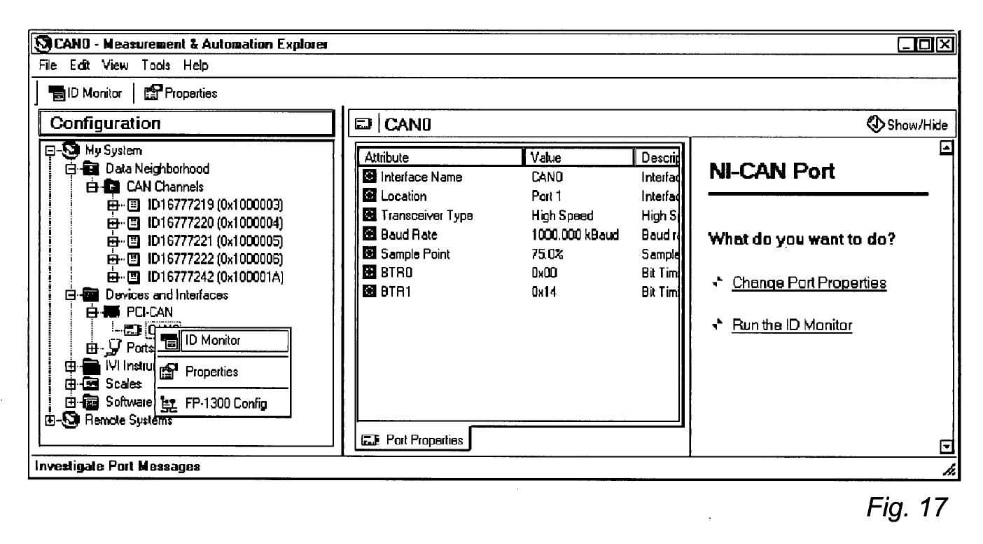

FIG. 17 illustrates the user using the graphical configuration tool to monitor the network device, according to one embodiment. For example, the user can monitor channels and check properties for a network device.

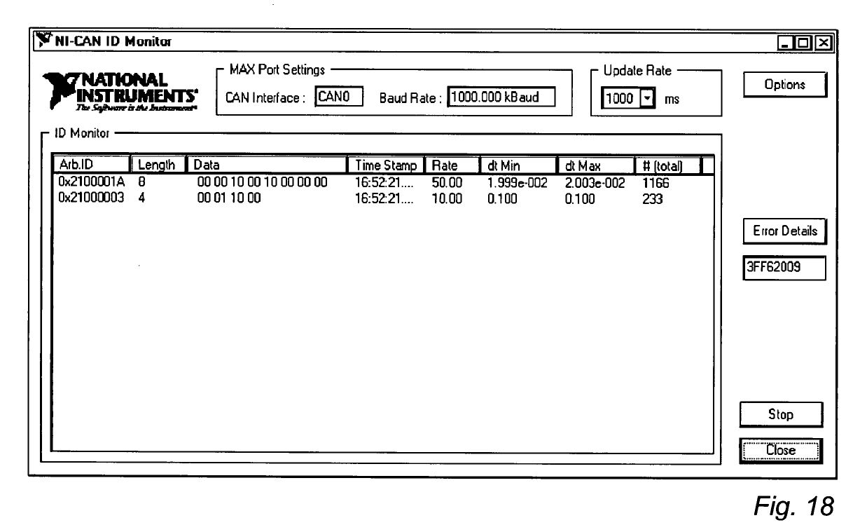

FIG. 18 illustrates the graphical configuration tool monitoring data on the network, according to one embodiment. For example, the data on an exemplary CAN interface 0 may be monitored.

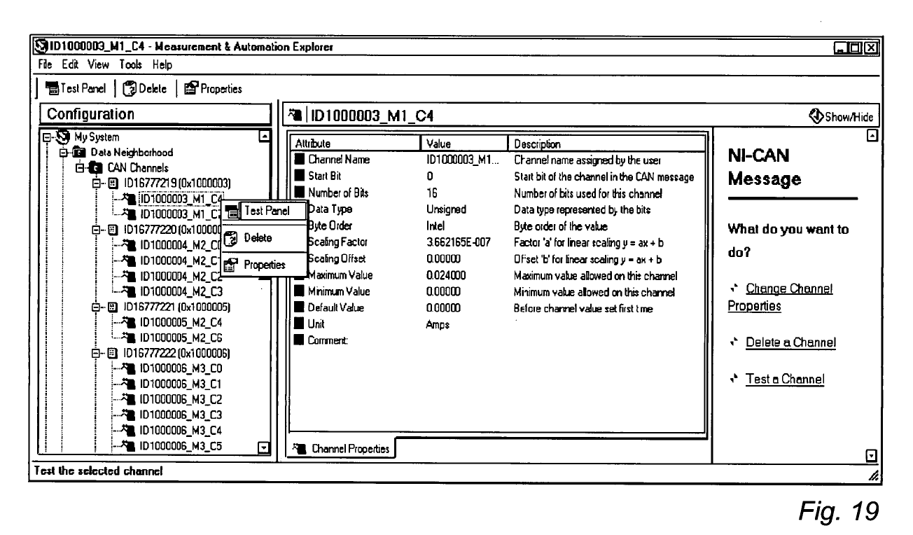

FIG. 19 illustrates accessing a test panel to test channels, according to one embodiment. For example, a test panel for an exemplary CAN Channel ID16777219 (0x1000003) may be accessed.

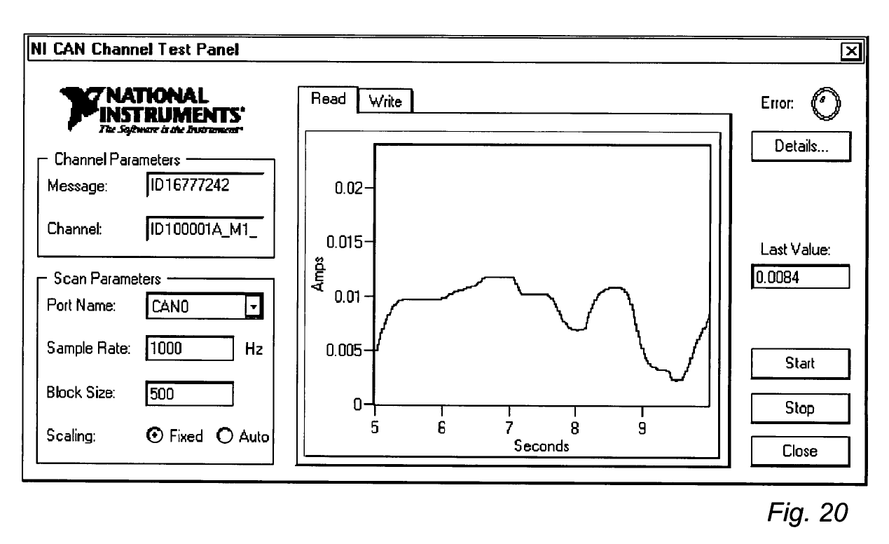

FIG. 20 illustrates using the test panel to read and write values, according to one embodiment. For example, a test panel may be used to read and display values of an exemplary CAN Channel D100001A_M1_C4 on a scope display. The values of the exemplary CAN channel may also be written.

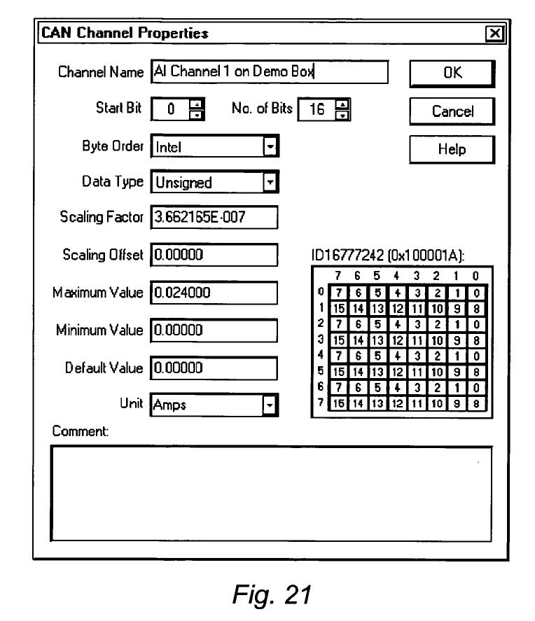

FIG. 21 illustrates accessing channel properties page, according to one embodiment. For example, CAN channel properties for an exemplary CAN Channel “AI Channel 1 on Demo Box” may be accessed to be viewed and/or changed.

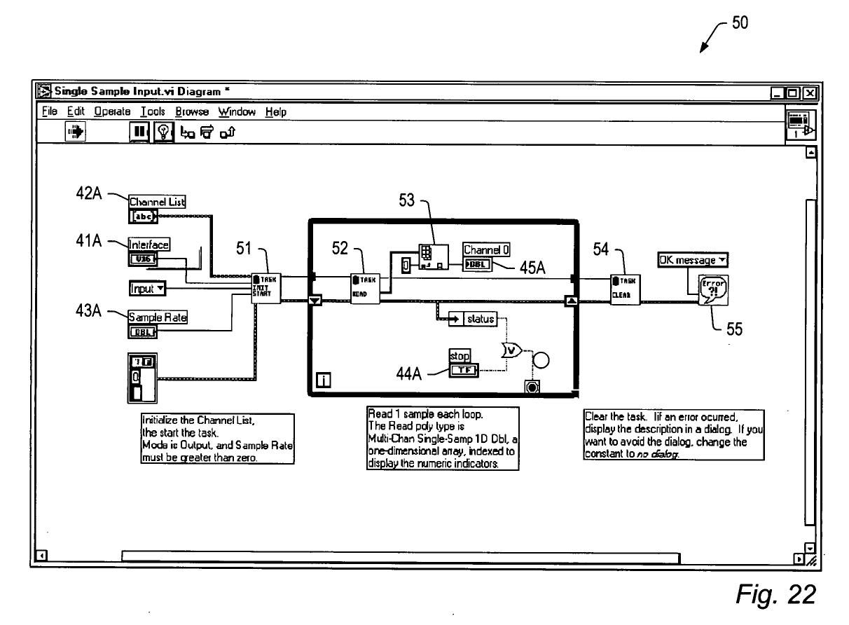

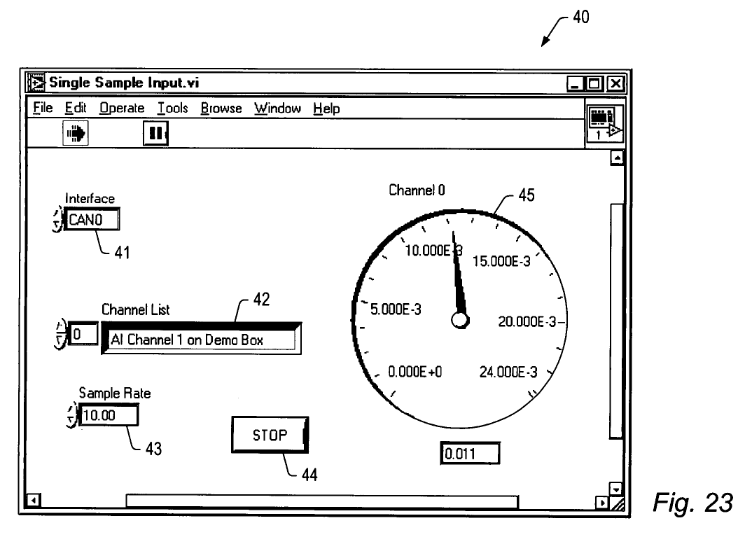

FIGS. 22-23—Using a Graphical Program to access Network Device

FIG. 22 illustrates a diagram of a graphical program that accesses data on the network, according to one embodiment. FIG. 23 illustrates a front panel of the graphical program that accesses data on the network, according to one embodiment.

As illustrated in FIG. 22, a user may assemble a graphical program by selecting various icons or nodes, such as icons and nodes 51-55 as well as terminals 41A-45A, that represent desired functionality, and then connecting the nodes together to create the graphical program. The nodes or icons may be connected by lines representing data flow between the nodes, control flow, or execution flow. Thus the block diagram, such as the block diagram 50, may include a plurality of interconnected icons 51-55 such that the diagram created graphically displays a procedure or method for accomplishing a certain result, such as manipulating one or more input variables and/or producing one or more output variables. In response to the user constructing a diagram or a graphical program using the block diagram editor, data structures and/or program instructions may be automatically constructed which characterize an execution procedure that corresponds to the displayed procedure. The graphical program may be compiled or interpreted by a computer.

As illustrated in FIG. 23, a graphical program may have a graphical user interface. For example, in creating a graphical program, a user may create a front panel 40 or a user interface panel. The front panel 40 may include various graphical user interface elements 41-45 or front panel objects, such as user interface controls and/or indicators, that represent or display the respective input and output that will be used by the graphical program, and may include other icons which represent devices being controlled. The graphical user interface elements 41-45 in the front panel may correspond to terminals 41A-45A in the block diagram respectively.

In one embodiment, a graphical program may communicate with one or more of the first network device and the second network device. The first data message is operable to be received and processed by the graphical program, such as the graphical program in FIGS. 22-23. The graphical program may be executed to perform an industrial automation function, a process control function, and a test and measurement function, among others.

In another embodiment, an application program communicating with one or more of the first network device and the second network device includes a program created in one or more of a C, C++, Java, Visual Basic, and any other program development environment.

Although the embodiments above have been described in considerable detail, numerous variations and modifications will become apparent to those skilled in the art once the above disclosure is fully appreciated. It is intended that the following claims be interpreted to embrace all such variations and modifications.

1. A communication network, wherein the communication network comprises:
a plurality of network devices coupled to the communication network, wherein the plurality of network devices are operable to communicate with each other over the communication network by transmitting and receiving one or more data messages;
a first network device of the plurality of network devices, wherein the first network device comprises at least one of one or more inputs and one or more outputs; and
a second network device of the plurality of network devices, wherein the second network device is coupled to a first computer system;
wherein a first data message of the one or more data messages comprises user configurable data, wherein the user configurable data is configured using the first computer system, wherein the first data message groups together one of a first of the one or more inputs and a second of the one or more inputs or a first of the one or more outputs and a second of the one or more outputs.

2. The communication network of claim 1,
wherein the network devices are further operable to transmit a configuration data message, wherein the configuration data message specifies content of the one or more data messages, wherein the configuration data message is created in response to said configuring.

3. The communication network of claim 1,
wherein the user configurable data is configured using the first computer system using a graphical configuration tool on the first computer system.

4. The communication network of claim 1,
wherein each one of the plurality of network devices comprises one or more of a transmitter and a receiver operable to said transmit and said receive the one or more data messages.

5. The communication network of claim 1,
wherein each one of the one or more inputs is operable to acquire one or more of analog and discrete data; and
wherein each one of the one or more outputs is operable to generate one or more of analog and discrete data.

6. The communication network of claim 1,
wherein at least one of the one or more data messages comprises at least one channel of one or more of analog data and discrete data; and
wherein the first data message comprises one or more message arbitration IDs, wherein each one of the one or more message arbitration IDs identifies the one or more channels in the first data message.

7. The communication network of claim 1,
wherein the first data message comprises one or more channels of analog data, wherein each one of the one or more channels of analog data comprises at least one byte of data.

8. The communication network of claim 1,
wherein the first data message comprises one or more channels of discrete data, wherein each one of the one or more channels of discrete data comprises at least one bit of data.

9. The communication network of claim 1,
wherein the first data message comprises one or more channels of analog data;
wherein the first data message further comprises one or more channels of discrete data; and
wherein the first data message is operable to combine one or more of the one or more channels of analog data and the one or more channels of discrete data.

10. The communication network of claim 1,
wherein the user configurable data is operable to be stored in a configuration file; and
wherein the configuration file is operable to be used by one or more applications on the first computer system.

11. The communication network of claim 1,
wherein the communication network comprises one or more of:
a CAN network;
a CANOPEN network;
a CAL network;
a DeviceNET network; and
any other type of an industrial network.

12. The communication network of claim 1, further comprising:
a graphical program that is operable to communicate with one or more of the first network device and the second network device;
wherein the first data message is operable to be received and processed by the graphical program.

13. The communication network of claim 12,
wherein the graphical program comprises a plurality of interconnected nodes that visually indicate functionality of the graphical program.

14. The communication network of claim 12,
wherein the graphical program comprises a block diagram portion and a user interface portion.

15. The communication network of claim 12,
wherein the graphical program comprises a graphical data flow program.

16. The communication network of claim 12,
wherein the graphical program is operable to perform one or more of:
an industrial automation function;
a process control function; and
a test and measurement function.

17. The communication network of claim 12,
wherein the graphical program is operable to be executed.

18. The communication network of claim 1, further comprising:
an application program that is operable to communicate with one or more of the first network device and the second network device;
wherein the first data message is operable to be received and processed by the application program;
wherein the application program comprises a program created in one or more of a C, C++, Java, Visual Basic, and any other program development environment.

19. The communication network of claim 1,
wherein the first network device further comprises one or more modules;
wherein a first of the one or more modules on the first network device comprises a network interface, wherein the network interface is operable to communicate on the communication network by said transmitting and said receiving the one or more data messages; and
wherein a second of the one or more modules on the first network device comprises at least one of the one or more inputs and the one or more outputs.

20. The communication network of claim 1,
wherein the first network device is operable to be used in one or more of device prototyping, automotive bench testing, in-vehicle testing, and data logging.

21. The communication network of claim 1,
wherein the first network device is operable to simulate a production device.

22. The communication network of claim 1,
wherein each one of the at least one of the one or more inputs and the one or more outputs can be updated by a network message by one or more of:
periodical determinism;
change of a state;
reaching a predetermined level; and
poll from the communication network.

23. The communication network of claim 22,
wherein the first network device contains a first data channel and a second data channel;
wherein the first network device is operable to transmit a first data message and a second data message; and
wherein the first data channel can be transmitted using a first mechanism using the first data message and the second data channel can be transmitted using a second mechanism using the second data message.

24. The communication network of claim 1,
wherein an acquisition of a first of the at least one of the one or more inputs and the one or more outputs by the first device is operable to trigger a transmission of data from a second of the at least one of the one or more inputs and the one or more outputs on the first device.

25. A flexible network system for network data transmission, wherein the data transmission occurs over a network, the flexible system comprising:
a first network device and a second network device, wherein both the first network device and the second network device are coupled to the network, wherein the first network device and the second network device are operable to communicate with each other using the communication network by transmitting and receiving one or more data messages, wherein the first network device comprises at least one of one or more inputs and one or more outputs, wherein the second network device comprises at least one of one or more inputs and one or more outputs; and
a graphical configuration tool operable to configure contents of a first data message of the one or more data messages, wherein said configuring operates on both the first network device and the second network device;
wherein the first network device is operable to generate the first data message, wherein the first data message is operable to be propagated and received by the second network device, wherein the first data message groups together one of a first of the one or more inputs and a second of the one or more inputs or a first of the one or more outputs and a second of the one or more outputs.

26. The flexible network system of claim 25,
wherein the network devices are further operable to transmit a configuration data message, wherein the configuration data message specifies content of the one or more data messages, wherein the configuration data message is created in response to said configuring.

27. The flexible network system of claim 25,
wherein each one of the one or more inputs is operable to acquire one or more of analog and discrete data; and
wherein each one of the one or more outputs is operable to generate one or more of analog and discrete data.

28. The flexible network system of claim 25,
wherein the first data message further comprises data from the at least one of the one or more inputs and the one or more outputs.

29. The flexible network system of claim 25,
wherein at least one of the one or more data messages comprises one or more channels of one or more of analog data and discrete data;
wherein the first data message comprises one or more message arbitration IDs, wherein each one of the one or more message arbitration IDs identifies the one or more channels in the first data message.

30. The flexible network system of claim 25, further comprising:
a first computer system coupled to the network; and
a graphical program, wherein the graphical program is operable to communicate with one or more of the first network device and the second network device;
wherein the first data message is operable to be received and processed by the graphical program.

31. The flexible network system of claim 30,
wherein the graphical program comprises a plurality of interconnected nodes that visually indicate functionality of the graphical program.

32. The flexible network system of claim 30,
wherein the graphical program comprises a block diagram portion and a user interface portion.

33. The flexible network system of claim 30,
wherein the graphical program comprises a graphical data flow program.

34. The flexible network system of claim 30,
wherein the graphical program is operable to perform one or more of:
an industrial automation function;
a process control function; and
a test and measurement function.

35. The flexible network system of claim 30,
wherein the graphical program is operable to be executed.

36. The flexible network system of claim 25,
wherein each one of the at least one of the one or more inputs and the one or more outputs can be updated by a network message by one or more of:
periodical determinism;
change of a state;
reaching a predetermined level; and
poll from the communication network.

37. The flexible network system of claim 36,
wherein the first network device contains a first data channel and a second data channel;
wherein the first network device is operable to transmit a first data message and a second data message; and
wherein the first data channel can be transmitted using a first mechanism using the first data message and the second data channel can be transmitted using a second mechanism using the second data message.

38. A method for configuring network communication between a plurality of network devices, the method comprising:
coupling a first network device out of the plurality of network devices to a network;
coupling a second network device out of the plurality of network devices to the network, wherein the network is operable to communicate one or more data messages between the first network device and the second network device, wherein each of the first network device and the second network device comprises at least one of one or more inputs and one or more outputs, wherein the second network device is coupled to a first computer system;
configuring the at least one of the one or more inputs and the one or more outputs on the first network device;
configuring the at least one of the one or more inputs and the one or more outputs on the second network device;
configuring a first data message of the one or more data messages, wherein the first data message comprises data for the at least one of the one or more inputs and the one or more outputs, wherein the first data message contains one of input data and output data; and
propagating the first data message from the first network device to the second network device.

39. The method of claim 38,
wherein the network devices are further operable to transmit a configuration data message, wherein the configuration data message specifies content of the one or more data messages, wherein the configuration data message is created in response to said configuring.

40. The method of claim 38,
wherein at least one of the one or more data messages comprises one or more channels of one or more of analog data and discrete data; and
wherein the first data message comprises one or more message arbitration IDs, wherein each one of the one or more message arbitration IDs identifies the one or more channels in the first data message

41. The method of claim 38, further comprising:
a graphical program communicating with one or more of the first network device and the second network device;
wherein the first data message is operable to be received and processed by the graphical program.

42. The method of claim 41,
wherein the graphical program comprises a plurality of interconnected nodes that visually indicate functionality of the graphical program.

43. The method of claim 41,
wherein the graphical program comprises a block diagram portion and a user interface portion.

44. The method of claim 41,
wherein the graphical program comprises a graphical data flow program.

45. The method of claim 41,
wherein the graphical program is operable to perform one or more of:
an industrial automation function;
a process control function; and
a test and measurement function.

46. The method of claim 41, further comprising:
executing the graphical program.

47. The method of claim 38, further comprising:
an application program communicating with one or more of the first network device and the second network device;
wherein the first data message is operable to be received and processed by the application program;
wherein the application program comprises a program created in one or more of a C, C++, Java, Visual Basic, and any other program development environment.

48. The method of claim 38,
wherein said configuring the at least one of the one or more inputs and the one or more outputs on the first network device comprises user graphically configuring the at least one of the one or more inputs and the one or more outputs on the first network device.

49. The method of claim 38,
wherein said configuring the at least one of the one or more inputs and the one or more outputs on the second network device comprises user graphically configuring the at least one of the one or more inputs and the one or more outputs on the second network device.

50. The method of claim 38,
wherein said configuring the first data message of the one or more data messages comprises user graphically configuring the first data message of the one or more data messages.

51. The method of claim 38,
wherein each one of the at least one of the one or more inputs and the one or more outputs can be updated by a network message by one or more of:
periodical determinism;
change of a state;
reaching a predetermined level; and
poll from the communication network.

52. The method of claim 51,
wherein the first network device contains a first data channel and a second data channel;
wherein the first network device is operable to transmit a first data message and a second data message; and
wherein the first data channel can be transmitted using a first mechanism using the first data message and the second data channel can be transmitted using a second mechanism using the second data message.

53. The method of claim 38,
wherein an acquisition of a first of the at least one of the one or more inputs and the one or more outputs by the first device is operable to trigger a transmission of data from a second of the at least one of the one or more inputs and the one or more outputs on the first device.
